(19) United States
(12) Patent Application Publication
(10) Pub. No.: US 2025/0252340 A1
(43) Pub. Date: Aug. 7, 2025

(54) REINFORCEMENT LEARNING USING LONG-TERM USER TRAJECTORY PROCESSING

(71) Applicant: Microsoft Technology Licensing, LLC, Redmond, WA (US)

(72) Inventors: Prakruthi Prabhakar, Santa Clara, CA (US); Borja Ocejo Elizondo, Chicago, IL (US); Ruofan Wang, Mountain View, CA (US); Ke Liu, San Jose, CA (US); Xiaoxiao Guo, Mountain View, CA (US); Fedor Vladimirovich Borisyuk, Mountain View, CA (US); Rohit Kumar Patra, Brooklyn, NY (US); Qiang Xiao, Sunnyvale, CA (US)

(21) Appl. No.: 18/431,916

(22) Filed: Feb. 2, 2024

(51) Int. Cl. G06N 20/00

(52) U.S. Cl. CPC G06N 20/00

(57) ABSTRACT

Methods, systems, and apparatuses include preprocessing data for input to a trained transformer system. User trajectory data for a user of an online system is received, the user trajectory data includes tuples for times at which the user interacted with the online system. The tuples are sorted based on the times to create a tuple sequence. Tuple subsequences are extracted from the tuple sequence based on a subsequence length. Cumulative rewards are calculated for the tuple subsequence based on rewards for the tuple subsequence. Input data is generated including cumulative rewards, action options, and the tuple subsequence. A best action option is determined by applying the trained transformer system to the input data. The best action option is implemented for the user of the online system.

### TECHNICAL FIELD

The present disclosure generally relates to machine learning, and more specifically, relates to reinforcement learning approaches to machine learning.

### BACKGROUND ART

Machine learning is a category of artificial intelligence. In machine learning, a model is defined by a machine learning algorithm. A machine learning algorithm is a mathematical and/or logical expression of a relationship between inputs to and outputs of the machine learning model. The model is trained by applying the machine learning algorithm to input data. A trained model can be applied to new instances of input data to generate model output. Machine learning model output can include a prediction, a score, or an inference, in response to a new instance of input data. Application systems can use the output of trained machine learning models to determine downstream execution decisions, such as decisions regarding various user interface functionality.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example user trajectory processing system that includes a user trajectory processing component in accordance with some embodiments of the present disclosure.

FIG. 2 illustrates another example user trajectory processing system that includes a user trajectory processing component in accordance with some embodiments of the present disclosure.

FIG. 3 illustrates another example computing system that includes a data tuple preprocessing component in accordance with some embodiments of the present disclosure.

FIG. 4 illustrates another example computing system that includes a trajectory preprocessing component in accordance with some embodiments of the present disclosure.

FIG. 5 illustrates another example computing system that includes a subsequence embedding component in accordance with some embodiments of the present disclosure.

FIG. 6 illustrates another example computing system that includes a causal transformer component in accordance with some embodiments of the present disclosure.

FIG. 7 is a flow diagram of an example method to process user trajectory data in accordance with some embodiments of the present disclosure.

FIG. 8 is a block diagram of an example computer system in which embodiments of the present disclosure can operate.

### DETAILED DESCRIPTION

Reinforcement learning uses artificial intelligence technology to make decisions based on observations of an environment and how the environment responds to actions. Reinforcement learning focuses on an agent operating in an unknown environment and determining optimal actions for the agent based on known information regarding the environment to reach a certain goal.

Reinforcement learning generates an optimal action policy that maximizes the expected cumulative reward for the environment. The cumulative reward for the environment can be framed as the value to the environment from the current state of the environment and into the future as a result of taking a current action (e.g., the outcome on the environment of a current action). The objective of reinforcement learning is therefore to discover an action policy that maximizes the average expected value for every state of a system. Given a current state of a system, a reinforcement learning method can generate an action policy that maximizes the average expected value for the system at the current state.

Reinforcement learning has many potential uses. However, there are shortcomings that present technical challenges to the widespread use of reinforcement learning. For example, reinforcement learning methods such as Q-learning and/or temporal difference, which rely on bootstrapping from the current estimate of the value function for the system, suffer from moving target problems, where the average expected values for the system change over time, invalidating the expected value assumptions at previous states. Attempts to overcome these bootstrapping problems involve training multiple action policies separately to account for every experience and integrating the policies into a single policy. This process, however, is very time consuming since the different action policies are trained separately and integration often requires recollecting data, retraining, and ramping combined policies. This time delay amplifies the inherent risks of moving target problems for temporal difference and similar reinforcement learning approaches.

The shortcomings of these reinforcement learning approaches are particularly acute when implemented in large online systems subject to frequent change. For example, conventional reinforcement learning approaches are often unstable in systems with larger state features, linear probability models, and meta-learning capabilities. Large online systems include systems that track historic data for large numbers of users interacting with the online system. For example, a large online system is a system that tracks data relating to a user using an online system for millions of users. Large online systems also include systems with large amounts of network nodes and/or content items. For example, a large online system is a system with millions of content items and/or millions or network nodes. The exact number of users, content items, and/or nodes is not what defines a large online system, but rather the amount of data to be processed by the online systems relating to these users, content items, and/or nodes. Additionally, conventional reinforcement learning systems which undergo changes in the rewards, states, and/or actions (such as the introduction of new rewards for certain actions) require substantial hyperparameter tuning to achieve optimal performance.

Additionally, convention reinforcement learning approaches rely on strict Markov decision process assumptions which provide substantial challenges when combining rankings with decision prediction. For example, when ranking potential notifications to send to a user of a large online system (e.g., a social graph network), conventional reinforcement learning methods struggle to integrate the notification ranking and decision prediction problems (e.g., picking which notification to send and the likely outcomes of sending that notification) because of the Markov decision process required by current methods. Furthermore, it is difficult to understand the convergence of convention reinforcement learning policies since there are few quantitative metrics to compare different policies. This lack of quantitative metrics leads to a heavy reliance on offline replay estimates for these approaches which can be biased and/or over tuned.

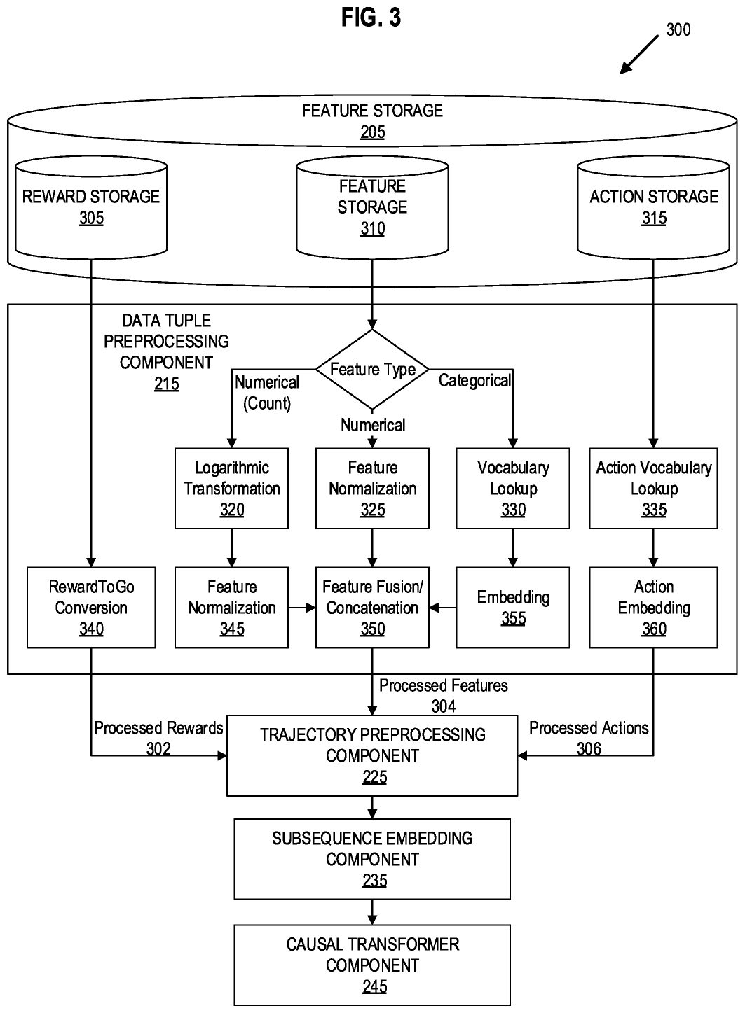

In reinforcement learning, a trajectory is the path of an agent in an unknown environment defined by the state space. User trajectory data refers to data relating to or concerning a user of an online system that defines the trajectory of that user interacting with the online system. Long-term user trajectory data includes historical user trajectory data for time periods longer than short instances in time. For example, long-term user trajectory data includes information about a user and the online system the user is interacting with for a period of a week. Further details regarding long-term user trajectory data are explained with reference to FIG. 3.

A reinforcement learning system using long-term user trajectory data as described herein includes a number of different components that alone or in combination address the above and other shortcomings of the conventional reinforcement learning technologies, particularly when applied to reinforcement learning for large online systems (e.g., social graph networks). For example, by formulating the reinforcement policy learning problem as a sequential trajectory modeling problem with return conditioning and prompting using causal transformers, the reinforcement learning system can bring more stability to training, resulting in fewer policies with a more accurate understanding of the convergence and quantitative training/evaluation metrics. Additionally, using long-term user trajectory data for sequential trajectory modeling removes the reliance on Markov decision process assumptions, resulting in better feature integration. Furthermore, using long-term user trajectory data for sequential trajectory modeling facilitates the addition of features, personalization of the reinforcement learning models, and meta learning, further adding to the stability of the approach.

By using long-term user trajectory data, the reinforcement learning system is able to use historical sequences of states, actions, and rewards during decision making (e.g., inference), rather than relying on bootstrapping on previous estimates. For example, rather than solely relying on a current state of a system to predict how a user will react to a notification, the reinforcement learning system uses long-term user trajectory data about how the user has historically reacted to notifications. This creates a system that is more sensitive to context, more robust in its understanding, and more capable of adapting to changing values over time. Such a system is more efficient in allocating resources due to more accurate and adaptable predictions. For example, user preferences change over time and based on external information, such as days of the week. A user may be more likely to interact with a notification on a weekend than on a Monday morning. Using long-term user trajectory data allows the system to take these changing user dynamics into account when determining whether to send a notification, improving the system allocation of resources when sending notifications.

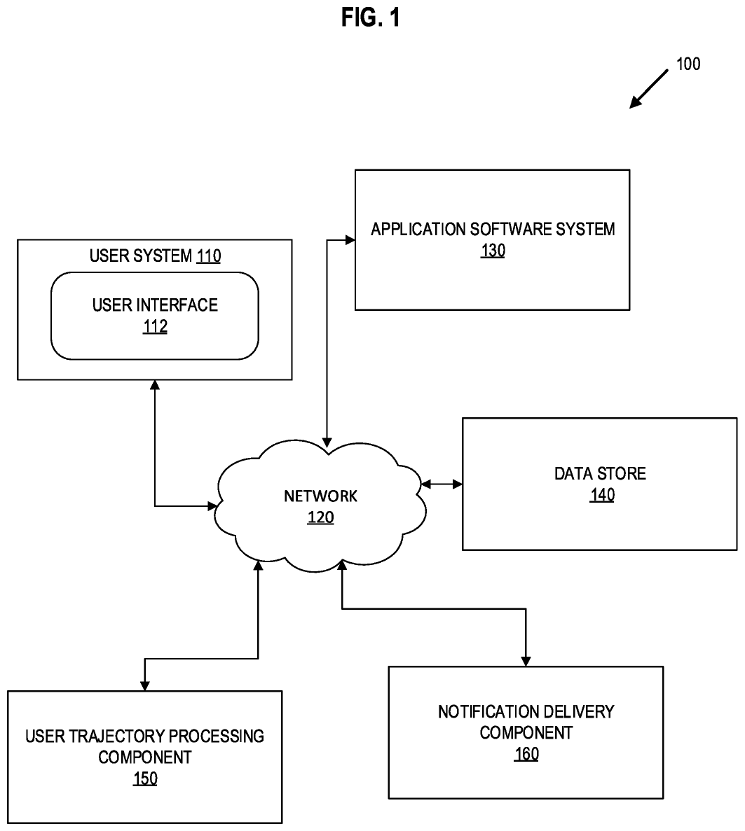

FIG. 1 illustrates an example of a user trajectory processing system that includes a user trajectory processing component in accordance with some embodiments of the present disclosure.

In the embodiment of FIG. 1, user trajectory processing system 100 includes a user system 110, a network 120, an application software system 130, a data store 140, a user trajectory processing component 150, and a notification delivery component 160. Each of these components of user trajectory processing system 100 are described in more detail below.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 can be or include a front-end portion of application software system 130.

User interface 112 is any type of user interface as described above. User interface 112 can be used to input search queries and view or otherwise perceive output that includes data produced by application software system 130. For example, user interface 112 can include a graphical user interface and/or a conversational voice/speech interface that includes a mechanism for entering a search query and viewing query results and/or other digital content. Examples of user interface 112 include web browsers, command line interfaces, and mobile apps. User interface 112 as used herein can include application programming interfaces (APIs).

Network 120 can be implemented on any medium or mechanism that provides for the exchange of data, signals, and/or instructions between the various components of user trajectory processing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

Application software system 130 is any type of application software system that includes or utilizes functionality and/or outputs provided by user trajectory processing component 150 and/or notification delivery component 160. Examples of application software system 130 include but are not limited to online services including connections network software, such as social media platforms, and systems that are or are not be based on connections network software, such as general-purpose search engines, content distribution systems including media feeds, bulletin boards, and messaging systems, special purpose software such as but not limited to job search software, recruiter search software, sales assistance software, advertising software, learning and education software, enterprise systems, customer relationship management (CRM) systems, or any combination of any of the foregoing.

A client portion of application software system 130 can operate in user system 110, for example as a plugin or widget in a graphical user interface of a software application or as a web browser executing user interface 112. In an embodiment, a web browser can transmit an HTTP request over a network (e.g., the Internet) in response to user input that is received through a user interface provided by the web application and displayed through the web browser. A server running application software system 130 and/or a server portion of application software system 130 can receive the input, perform at least one operation using the input, and return output using an HTTP response that the web browser receives and processes.

While not specifically shown, it should be understood that any of user system 110, application software system 130, data store 140, user trajectory processing component 150, and notification delivery component 160 includes an interface embodied as computer programming code stored in computer memory that when executed causes a computing device to enable bidirectional communication with any other of user system 110, application software system 130, data store 140, user trajectory processing component 150, and notification delivery component 160 using a communicative coupling mechanism. Examples of communicative coupling mechanisms include network interfaces, inter-process communication (IPC) interfaces and application program interfaces (APIs).

Data store 140 can include any combination of different types of memory devices. Data store 140 stores digital data used by user system 110, application software system 130, user trajectory processing component 150, and/or notification delivery component 160. Data store 140 can reside on at least one persistent and/or volatile storage device that can reside within the same local network as at least one other device of user trajectory processing system 100 and/or in a network that is remote relative to at least one other device of user trajectory processing system 100. Thus, although depicted as being included in user trajectory processing system 100, portions of data store 140 can be part of user trajectory processing system 100 or accessed by user trajectory processing system 100 over a network, such as network 120.

Each of user system 110, application software system 130, data store 140, user trajectory processing component 150, and notification delivery component 160 is implemented using at least one computing device that is communicatively coupled to electronic communications network 120. Any of user system 110, application software system 130, data store 140, user trajectory processing component 150, and notification delivery component 160 can be bidirectionally communicatively coupled by network 120. User system 110 as well as one or more different user systems (not shown) can be bidirectionally communicatively coupled to application software system 130.

A typical user of user system 110 can be an administrator or end user of application software system 130, user trajectory processing component 150, and/or notification delivery component 160. User system 110 is configured to communicate bidirectionally with any of application software system 130, data store 140, user trajectory processing component 150, and/or notification delivery component 160 over network 120.

The features and functionality of user system 110, application software system 130, data store 140, user trajectory processing component 150, and notification delivery component 160 are implemented using computer software, hardware, or software and hardware, and can include combinations of automated functionality, data structures, and digital data, which are represented schematically in the figures. User system 110, application software system 130, data store 140, user trajectory processing component 150, and notification delivery component 160 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner.

The user trajectory processing component 150 processes long-term user trajectory data for a user in a large online system (e.g., a social graph network) and determines an optimal action policy based on the long-term user trajectory data. Further details with regard to the operations of user trajectory processing component 150 are described below.

The notification delivery component 160 sends notifications to a user of the large online system based on the optimal action policy determined by user trajectory processing component 150. Further details with regard to the operations of notification delivery component 160 are described below.

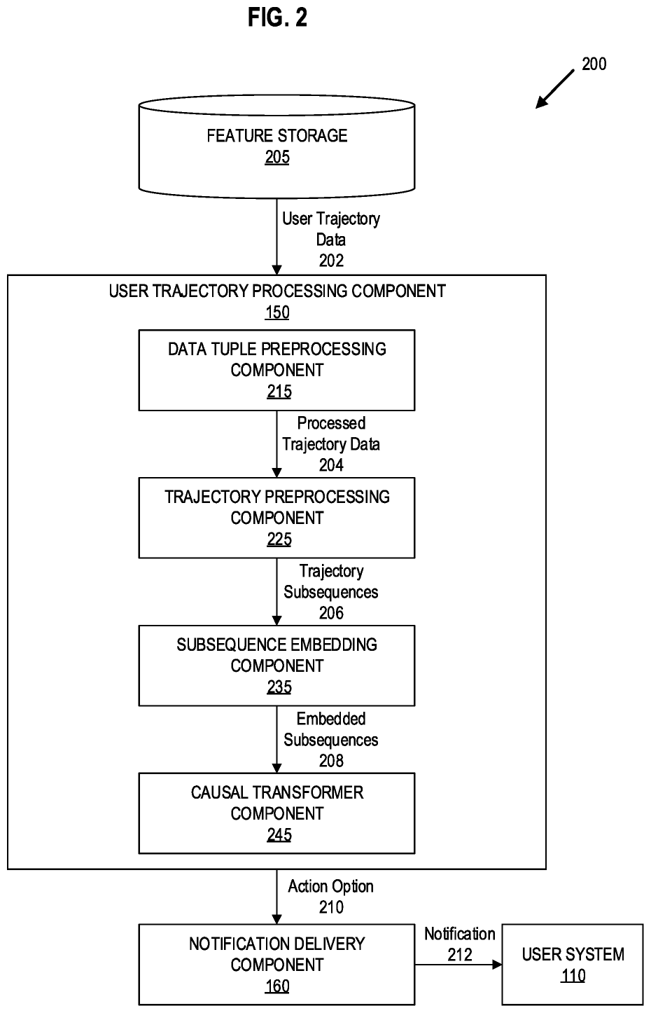

FIG. 2 illustrates an example of a user trajectory processing system that includes a user trajectory processing component in accordance with some embodiments of the present disclosure.

In the embodiment of FIG. 2, user trajectory processing system 200 includes feature storage 205, user trajectory processing component 150, and notification delivery component 160. User trajectory processing component 150 includes data tuple preprocessing component 215, trajectory preprocessing component 225, subsequence embedding component 235, and causal transformer component 245. Each of these components of user trajectory processing system 200 are described in more detail below.

Feature storage 205 sends user trajectory data 202 to user trajectory processing component 150. Feature storage 205 is a data storage that includes digital data for an online system (e.g., a social graph network). In some embodiments, feature storage 205 is included in a data store of a user trajectory processing system 100 (e.g., data store 140 of FIG. 1). Feature storage 205 stores user trajectory data 202 for users of the online system. User trajectory data 202 can include rewards (e.g., outcomes), actions, and features (including both context and state features) for a user of an online system. In some embodiments, user trajectory processing system 200 is a multi-objective system and thus the rewards for user trajectory data 202 are multi-objective. For example, user trajectory data 202 includes different reward values for different objectives of user trajectory processing system 200. Further details with regard to feature storage 205 are described with reference to FIG. 3.

User trajectory processing component 150 receives user trajectory data 202 from feature storage 205. Data tuple preprocessing component 215 of user trajectory processing component 150 generates processed trajectory data 204 by processing user trajectory data 202. For example, data tuple preprocessing component 215 takes the raw user trajectory data 202 and processes it for input into a transformer system (e.g., causal transformer component 245). Data tuple preprocessing component 215 sends processed trajectory data 204 to trajectory preprocessing component 225. Further details with regard to data tuple preprocessing component 215 are described with reference to FIG. 3.

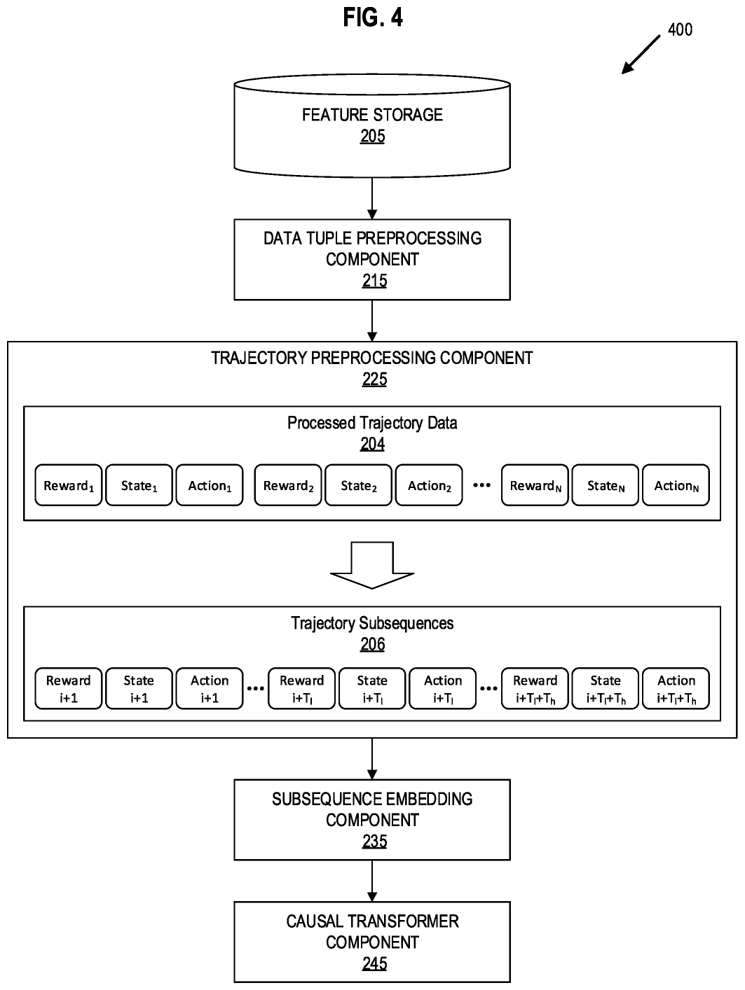

Trajectory preprocessing component 225 receives processed trajectory data 204 and generates trajectory subsequences 206 using processed trajectory data 204. For example, trajectory preprocessing component 225 generates trajectory subsequences 206 from processed trajectory data 204 based on a subsequence length. In some embodiments, trajectory preprocessing component 225 generates trajectory subsequences 206 of a different subsequence length during training for a transformer system (e.g., causal transformer component 245) than for during evaluation and/or inference. Trajectory preprocessing component 225 sends trajectory subsequences 206 to subsequence embedding component 235. Further details with regard to trajectory preprocessing component 225 are described with reference to FIG. 4.

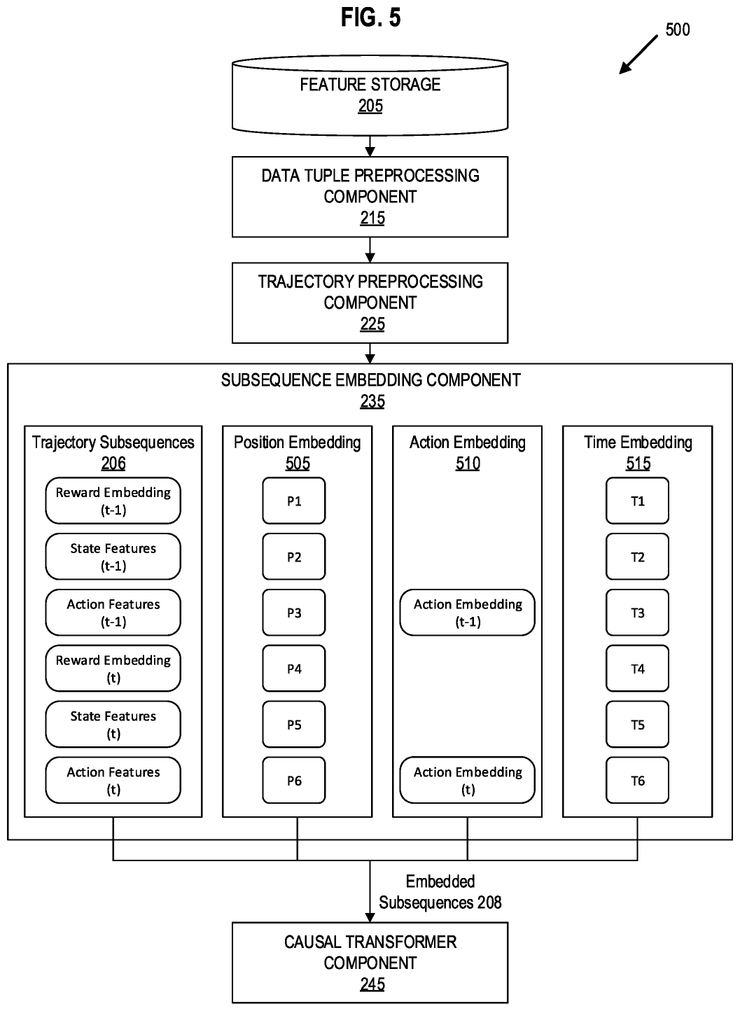

Subsequence embedding component 235 receives trajectory subsequences 206 and generates embedded subsequences 208. For example, subsequence embedding component 235 embeds trajectory subsequences 206 with positional embeddings, action embeddings, and time embeddings. In some embodiments, although illustrated separately for clarity, subsequence embedding component 235 is included in causal transformer component 245. Additionally, although described as embedding, subsequence embedding component 235 can also perform encoding functions (e.g., positional encoding). Subsequence embedding component 235 sends embedded subsequences 208 to causal transformer component 245. Further details with regard to subsequence embedding component 235 are described with reference to FIG. 5.

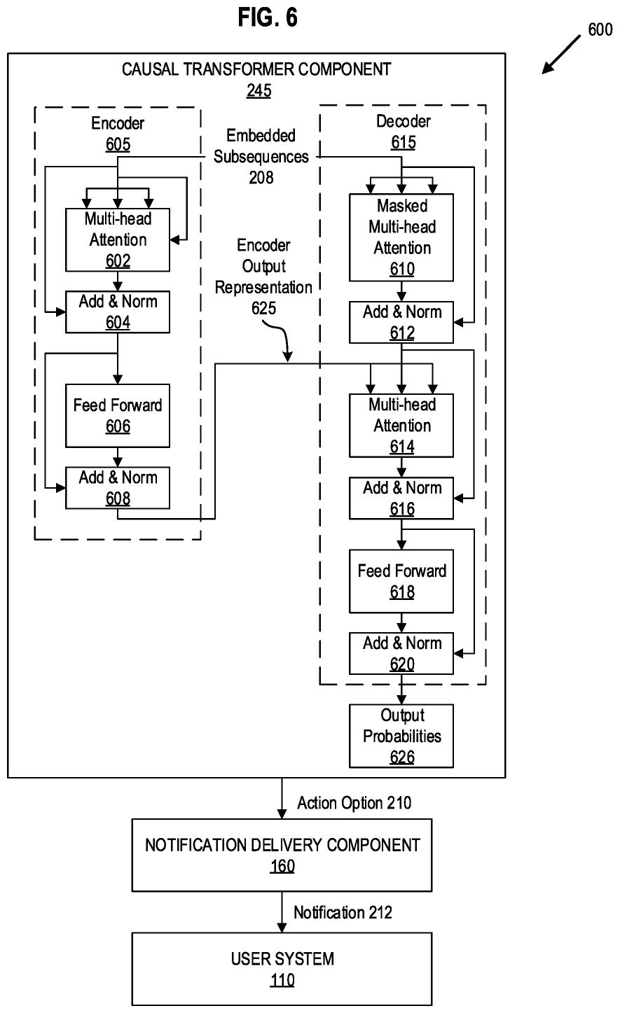

Causal transformer component 245 receives embedded subsequences 208 and generates action option 210. For example, causal transformer component 245 inputs embedded subsequences 208 into a causal transformer model which generates an action policy that maximizes the expected rewards for a system based on embedded subsequences 208. User trajectory processing component 150 sends action option 210, generated by causal transformer component 245, to notification delivery component 160. Further details with regard to causal transformer component 245 are described with reference to FIG. 6.

Notification delivery component 160 receives action option 210 and generates notification 212 to send to user system 110. For example, notification delivery component 160 determines notification 212 that matches the action option 210 determines by user trajectory processing component 150 and sends notification 212 to user system 110, causing user system 110 to display notification 212 on a user interface of user system 110 (e.g., user interface 112 of FIG. 1). Further details with regard to notification delivery component 160 are described with reference to FIG. 6.

FIG. 3 illustrates an example computing system that includes a data tuple preprocessing component in accordance with some embodiments of the present disclosure.

In the embodiment of FIG. 3, computing system 300 includes feature storage 205, data tuple preprocessing component 215, trajectory preprocessing component 225, subsequence embedding component 235, and causal transformer component 245. Feature storage 205 includes reward storage 305, feature storage 310, and action storage 315. Data tuple preprocessing component 215 includes logarithmic transformation 320, feature normalization 325, vocabulary lookup 330, action vocabulary lookup 335, RewardToGo conversion 340, feature normalization 345, feature fusion/concatenation 350, embedding 355, and action embedding 360. Each of feature storage 205 and data tuple preprocessing component 215 of computing system 300 are described in more detail below.

Reward storage 305, feature storage 310, and action storage 315 are data storage components for historical user data. For example, feature storage 310 includes features for historical states of an online system for a user. These historical state features can include user level features and system level features. In some embodiments, user level features are context features which are extracted once per user trajectory. For example, user level features include features including a country that a user lives in, a number of connections that a user has, an identifier for the user (e.g., identifying the user as a recruiter, student, or other member of a social graph network), the last time a user logged into the online system, a number of times the user clicked a notification, a number of times the user was sent a notification, a number of times the user saw a notification, and similar user level features. Because these user level features remain nearly constant, they are treated as context features. In some embodiments, these context features are appended at the beginning of the inputs to causal transformer component 245. In such embodiments, the multi-head attention mechanism (e.g., multi-head attention layers 602, 610, and 614) of causal transformer component 245 thereby uses these appended context features in the action prediction. Therefore, although illustrated as a single category, in some embodiments, features include both context features which are static for a user trajectory and state features which take different values for different times of a user trajectory.

In some embodiments, the system level features dynamically change for a given user and their values are therefore parameters that capture details about the environment (e.g., states of the online system). These system level features will differ based on the task of the reinforcement learning model. For example, for a reinforcement learning model tasked with determining whether to send a notification to a user, the system level features can include whether a notification type is capped, a tap score for a notification (e.g., a probability of the user interacting with the notification), a notification type, an hour of the day, a day of the week, a number of hours since the last badge notification was sent, a number of hours since the last push notification was sent, a number of hours since the last login to the online system, whether notifications are capped, whether the cap has been reached for the notification type, a size of the notification queue, a current notification badge count, a current app badge count, and similar notification specific features. Because the system level features dynamically change for a given user, they are treated as state features of the online system.

Action storage 315 includes historical actions performed by an online system for a user. For example, for a task of determining whether to deliver a notification, action storage 315 includes a historical list of times the online system determined to send or not send a notification and the type of notification the online system decided to send. Reward storage 305 includes historical outcomes (i.e., rewards) for actions performed by the online system for a user. For example, for a task of determining whether to deliver a notification, reward storage 305 includes whether the user saw the notification and whether the user interacted with the notification. Action storage 315 includes a historical count of actions taken at various times and reward storage 305 includes a historical count of the rewards for those actions taken at various times. The rewards, state features, and actions form a data tuple for a given time. For example, feature storage 310 includes state features for a user on Aug. 3, 2023 at 10:03 pm PST, action storage 315 includes an action taken by the online system for that user on Aug. 3, 2023 at 10:03 pm PST, and reward storage 305 includes an reward for the action taken by the online system on Aug. 3, 2023, at 10:03 pm PST. A single combination of a state feature at a given time, the action taken by the online system at that given time, and the reward for the action taken will be referred to as a data tuple. In some embodiments, the context features can also be included as part of this data tuple although the same context features may be shared by multiple data tuples.

Data tuple preprocessing component 215 retrieves features from feature storage for a given user and converts the raw feature data into unified length vectors. For example, data tuple preprocessing component 215 retrieves user trajectory data 202 for a specific user of an online system and processes the features of user trajectory data 202 based on the feature type.

Data tuple preprocessing component 215 applies a logarithmic transformation 320 to the numerical count features, transforming skewed distributions into more normalized distributions. For example, data tuple preprocessing component 215 applies a logarithmic transformation of log (x+1.5) to the numerical count data. Data tuple preprocessing component 215 then applies feature normalization 345 to the logarithmically transformed numerical count features. For example, data tuple preprocessing component 215 scales the logarithmically transformed numerical count features to a range from zero to one. Data tuple preprocessing component 215 then applies feature fusion/concatenation 350 to the numerical count features, combining them with the numerical and categorical features.

Data tuple preprocessing component 215 applies feature normalization 325 to the numerical features that are not counts. For example, data tuple preprocessing component 215 scales the numerical features to a range from zero to one. Data tuple preprocessing component 215 then applies feature fusion/concatenation 350 to the numerical features, combining them with the numerical count and categorical features.

Data tuple preprocessing component 215 applies a vocabulary lookup 330 and embedding 355 to the categorical features. For example, data tuple preprocessing component 215 applies vocabulary lookup 330 and an embedding 355 to the categorical features to generate a numerical vector based on the semantic meaning of the categorical features. In some embodiments, data tuple preprocessing component 215 applies a one-hot embedding to the categorical features. In some embodiments, data tuple preprocessing component 215 applies a dense embedding to the categorical features. In some embodiments, data tuple preprocessing component 215 applies a Quotient-Remainder (QR) embedding to the categorical features. Data tuple preprocessing component 215 then applies feature fusion/concatenation 350 to the categorical features, combining them with the numerical and numerical count features.

Data tuple preprocessing component 215 applies feature fusion/concatenation 350 to the processed numerical count features, numerical features, and categorical features to create processed features 304. For example, data tuple preprocessing component 215 applies feature fusion/concatenation to join the processed numerical count features, numerical features, and categorical features into a single feature vector (e.g., processed features 304). In some embodiments, data tuple preprocessing component 215 uses a feature fusion method such as LatentCross or other similar method to create processed features 304.

Data tuple preprocessing component 215 applies a RewardToGo conversion 340 to rewards retrieved from reward storage 305. For example, data tuple preprocessing component 215 retrieves rewards for a user of an online system from reward storage 305 and applies RewardToGo conversion 340 to generate processed rewards 302. In some embodiments, data tuple preprocessing component 215 applies a different RewardToGo conversion 340 for training causal transformer component 245 and for evaluating feature normalization 345. For example, when training a transformer system (e.g., causal transformer component 245), data tuple preprocessing component 215 uses a finite horizon reward-to-go value based on a period of time that the training data was collected (e.g., one week). For that week, data tuple preprocessing component 215 retrieves user trajectory data 202 with a length of T+T_{H}, where T_{H} is the horizon, a non-negative integer indicating the number of future steps in computing reward-to-go values and T is a timestep of user trajectory data 202. Data tuple preprocessing component 215 therefore applies RewardToGo conversion 340 for every timestep of user trajectory data 202 until time step T (since there would not be a full horizon length for any timesteps beyond T).

In some embodiments, data tuple preprocessing component 215 applies RewardToGo conversion 340 according to the following equation: Rᵢ^{h}=Σₜ₌₀^{T}^{_{H}}γ^{t}rᵢ₊ₜ, where rᵢ₊ₜ is the reward at time step i+t and γ is the discount factor that ranges between zero and one. The discount factor γ is a factor that influences how important a certain time step is in the reward-to-go calculation. For example, the further in the past a reward, the lower the value of γ for that reward. This reward-to-go calculation assumes the same horizon length accounts for the same reward-to-go computation at each time step.

In some embodiments, data tuple preprocessing component 215 applies RewardToGo conversion 340 according to the following equation: Rᵢ^{h}=Σₜ₌ᵢ^{T+T}^{_{H}}⁻¹γ^{t-1}rₜ, where i∈[1, T+T_{H}−1], rₜ is the reward at time step t, and γ is the discount factor that ranges between zero and one. This reward-to-go calculation simulates the returns being subtracted at each time step while providing enough horizon length for the final step in user trajectory data 202.

In some embodiments, during inference as well as evaluation, future reward values are unknown and cannot be calculated. In such embodiments, data tuple preprocessing component 215 uses constant reward-to-go conditioning or adaptive reward-to-go conditioning. In embodiments using constant reward-to-go conditioning, data tuple preprocessing component 215 uses a constant value for the unknown future reward-to-gos. For example, data tuple preprocessing component 215 calculates the future reward-to-gos based on the following equation: \hat{R}ᵢ=c, where c is the average of the top 5% of reward-to-go values from training. In some embodiments, data tuple preprocessing component 215 c is a tuned hyperparameter to determine the constant value for future reward-to-gos.

In embodiments using adaptive reward-to-go conditioning, data tuple preprocessing component 215 changes the reward-to-go values. In some embodiments, data tuple preprocessing component 215 subtracts cumulative rewards from the reward-to-go conditioning at every time step. For example, data tuple preprocessing component 215 calculates the future reward-to-gos based on the following equation: \hat{R}ᵢ=c−Σₜ₌₁ⁱ⁻γ^{t-1}rₜ, where γ is the discount factor, rₜ is the reward at time t, c is the average of the top 5% of reward-to-go values from training, and r₀=0. In some embodiments, data tuple preprocessing component 215 c is a tuned hyperparameter to determine the constant value for future reward-to-gos.

Data tuple preprocessing component 215 applies an action vocabulary lookup 335 and action embedding 360 to actions retrieved from action storage 315 and generates processed actions 306. For example, data tuple preprocessing component 215 applies vocabulary lookup 335 and an action embedding 360 to the actions to generate a numerical vector (e.g., processed actions) for each action based on the meaning of the action (e.g., action embedding 510 of FIG. 5). In some embodiments, action vocabulary lookup 335 uses data from a pre-established taxonomy stored in a data store (e.g., data store 140 of FIG. 1). For example, action vocabulary lookup 335 uses a pre-established taxonomy based on human labeled data stored in a data store.

Data tuple preprocessing component 215 sends processed rewards 302, processed features 304, and processed actions 306 to trajectory preprocessing component 225. For example, data tuple preprocessing component 215 sends a sequence of processed rewards 302, a sequence of processed features 304, and a sequence of processed actions 306 to trajectory preprocessing component 225. Trajectory preprocessing component 225 arranges the receives processed rewards 302, processed features 304, and processed actions 306 sequences by interleaving them into a single processed trajectory data sequence such as processed trajectory data 204 of FIG. 2.

FIG. 4 illustrates an example computing system that includes a trajectory preprocessing component in accordance with some embodiments of the present disclosure.

In the embodiment of FIG. 4, computing system 400 includes feature storage 205, data tuple preprocessing component 215, trajectory preprocessing component 225, subsequence embedding component 235, and causal transformer component 245. Trajectory preprocessing component 225 of computing system 400 is described in more detail below.

Trajectory preprocessing component 225 receives processed rewards 302, processed features 304, and processed actions 306 sequences as described with reference to FIG. 3. Trajectory preprocessing component 225 generates processed trajectory data 204 by arranging the components in each of processed rewards 302, processed features 304, and processed actions 306 into a single sequence of processed trajectory data 204. For example, each of processed rewards 302, processed features 304, and processed actions 306 include rewards, features, and actions are associated with a timestamp in the user trajectory. Trajectory preprocessing component 225 generates processed trajectory data 204 by sorting the processed rewards, processed features, and processed actions based on their associated time stamp. In some embodiments, trajectory preprocessing component 225 generates processed trajectory data 204 by interleaving processed rewards 302, processed features 304, and processed actions 306 in the order of rewards, features, and actions. In some embodiments, as explained above, context features (e.g., features that do not change for different timestamps) are appended to the beginning of the inputs to causal transformer component 245 rather than interleaved into processed trajectory data 204.

As shown in FIG. 4, processed trajectory data 204 can therefore include a sequence of N data tuples, where each data tuple includes a reward, state, and action for a specific timestamp. In some embodiments, the user trajectory for such a sequence is represented as a sequence of {(rᵢ, sᵢ, aᵢ)_{i=1,2, . . . , N}}, where rᵢ is the processed rewards for the timestamp i, sᵢ is the processed state features for the timestamp i, and aᵢ is the processed actions for the timestamp i. Trajectory preprocessing component 225 extracts multiple subsequences from processed trajectory data 204 according to the transformer configuration for causal transformer component 245. In some embodiments, since the reward-to-gos may be calculated differently for training, evaluation, and inference, the reward column in trajectory subsequences 206 differs for training, evaluation, and inference.

In some embodiments, trajectory preprocessing component 225 generates trajectory subsequences 206 as consecutive tuples from processed trajectory data 204 equal to a subsequence length. For example, trajectory preprocessing component 225 generates trajectory subsequences 206 from processed trajectory data 204 using an inference subsequence length, Tₗ, which is the length of subsequences used when generating trajectory subsequences 206 for inference and is the number of historical features (e.g., the number data tuples) fed to causal transformer component 245 for prediction. In some embodiments, the inference subsequence length is a hyperparameter of causal transformer component 245. For example, an optimal inference subsequence length is predetermined for causal transformer component 245.

In some embodiments, trajectory preprocessing component 225 converts processed trajectory data 204 to trajectory subsequences 206 for training causal transformer component 245. For example, trajectory preprocessing component 225 generates N−Tₗ−Tₕ+1 trajectory subsequences 206 of length Tₗ+Tₕ, where Tₗ is the inference subsequence length and Th is the reward-to-go horizon length. The reward-to-go horizon length, as discussed with reference to data tuple preprocessing component 215 and RewardToGo conversion 340 of FIG. 3, is a non-negative integer indicating how many future steps are used in computing reward-to-go values. In some embodiments, the reward-to-go horizon length is a hyperparameter of causal transformer component 245. For example, an optimal reward-to-go horizon length is predetermined for causal transformer component 245.

In such an example, a first trajectory subsequence of the N−Tₗ−Tₕ+1 trajectory subsequences 206 is represented as {(rₙ, sₙ, aₙ)_{n=1,2, . . . , T}_{ₗ}_{+T}_{ₕ}}, a second trajectory sequence is represented as {(rₙ, sₙ, aₙ)_{n=2,3, . . . , T}_{ₗ}_{+T}_{ₕ}₊₁}, and so on, such that any trajectory subsequence n of the N−Tₗ−Tₕ+1 trajectory subsequences 206 are represented as {(rₙ, sₙ, aₙ)_{n=i+1,i+2, . . . , i+T}_{ₗ}_{+T}_{ₕ}} as shown in FIG. 4.

In some embodiments, although illustrated as generating trajectory subsequences 206 from processed rewards 302, trajectory preprocessing component 225 generates trajectory subsequences 206 using reward data from reward storage 305 and data tuple preprocessing component 215 applies RewardToGo conversion 340 on the rewards to generate trajectory subsequences 206. For example, during training, data tuple preprocessing component 215 applies a finite horizon reward-to-go conversion on rewards in trajectory subsequences 206 to get the real reward-to-go values (e.g., processed rewards 302) and the first Tₗ elements are used in training as the trailing elements with reward-to-go values. In such embodiments, trajectory preprocessing component 225 generates {(rᵢ₊ₜ, sᵢ₊ₜ, aᵢ₊ₜ)_{t=1,2, . . . , T}_{ₗ}_{+T}_{ₕ}}, where rᵢ₊ₜ is the rewards for timestamp i+t, sᵢ₊ₜ is the state features for timestamp i+t, and aᵢ₊ₜ is the actions for timestamp i+t. Data tuple preprocessing component 215 applies RewardToGo conversion 340 to {(rᵢ₊ₜ, sᵢ₊ₜ, aᵢ₊ₜ)_{t=1,2, . . . , T}_{ₗ}_{+T}_{ₕ}} and generates {(Rᵢ₊ₜ^{h}, sᵢ₊ₜ, aᵢ₊ₜ)_{t=1,2, . . . , T}_{ₗ}_{+T}_{ₕ}}, where Rᵢ₊ₜ^{h} is the real reward-to-go value for timestamp i+t. In some embodiments, data tuple preprocessing component 215 uses the first Tₗ elements in training as the trailing elements with reward-to-go values. For example, data tuple preprocessing component 215 uses {(Rᵢ₊ₜ^{h}, sᵢ₊ₜ, aᵢ₊ₜ)_{t=1,2, . . . , T}_{ₗ}} as the trailing elements.

In some embodiments, trajectory preprocessing component 225 converts processed trajectory data 204 to trajectory subsequences 206 for evaluating causal transformer component 245 and/or for inference using causal transformer component 245. For example, trajectory preprocessing component 225 generates N−Tₗ+1 trajectory subsequences 206 of length Tₗ. In such an example, a first trajectory subsequence of the N−Tₗ+1 trajectory subsequences 206 is represented as {(rₙ, sₙ, aₙ)_{n=1,2, . . . , T}_{ₗ}}, a second trajectory sequence is represented as {(rₙ, sₙ, aₙ)_{n=2,3, . . . , 1+T}_{ₗ}}, and so on, such that any trajectory subsequence n of the N−Tₗ+1 trajectory subsequences 206 are represented as {(rₙ, sₙ, aₙ)_{n=i+1,i+2, . . . , i+T}_{ₗ}}.

In some embodiments, although illustrated as generating trajectory subsequences 206 from processed rewards 302, trajectory preprocessing component 225 generates trajectory subsequences 206 using reward data from reward storage 305 and data tuple preprocessing component 215 applies RewardToGo conversion 340 on the rewards to generate trajectory subsequences 206. For example, during evaluation and/or inference, data tuple preprocessing component 215 applies a reward-to-go conditioning scheme as explained above with reference to data tuple preprocessing component 215 and RewardToGo conversion 340 of FIG. 3. In some embodiments, as explained above, data tuple preprocessing component 215 uses constant reward-to-go conditioning or adaptive reward-to-go conditioning. In such embodiments, data tuple preprocessing component 215 applies RewardToGo conversion 340 using one of these reward-to-go conditioning schemes on rewards in trajectory subsequences 206 to generate processed rewards 302 and the first Tₗ−1 elements are discarded in evaluation and/or inference.

Trajectory preprocessing component 225 sends trajectory subsequences 206 to subsequence embedding component 235 for embedding and/or encoding and input into causal transformer component 245. Although illustrated as separate components for simplicity, subsequence embedding component 235 and causal transformer component 245 can be included in the same component. For example, a transformer system includes both an embedding/encoding component, such as subsequence embedding component 235, as well as transformer layers as explained with reference to causal transformer component 245 of FIG. 6.

FIG. 5 illustrates an example computing system that includes a subsequence embedding component in accordance with some embodiments of the present disclosure.

In the embodiment of FIG. 5, computing system 500 includes feature storage 205, data tuple preprocessing component 215, trajectory preprocessing component 225, subsequence embedding component 235, and causal transformer component 245. Subsequence embedding component 235 of computing system 500 is described in more detail below.

As shown in FIG. 5, subsequence embedding component 235 receives trajectory subsequences 206 and generates embedded subsequences 208 from trajectory subsequences 206. In some embodiments, subsequence embedding component 235 applies positional encoding to trajectory subsequences 206. For example, subsequence embedding component 235 applies a position embedding 505 based on the position of the data point in trajectory subsequences 206. For example, a first element of trajectory subsequences 206 has a position embedding of P1, a second element of trajectory subsequences 206 has a position embedding of P2, and so on. By including position embedding 505 during training, subsequence embedding component 235 ensures that causal transformer component 245 learns relations of position to the item in the sequence to learn its importance. For example, causal transformer component 245 can learn that rewards, state features, and actions with similar position embeddings (e.g., P1, P2, and P3) are associated with each other.

In some embodiments, subsequence embedding component 235 also applies action embedding 510 to action features of trajectory subsequences 206. For example, for each data tuple in trajectory subsequences 206, subsequence embedding component 235 applies embedding 510 for the action in that data tuple. Action embedding 510 helps the model learn the representation and meaning of each action. For example, actions can include notifications and action embedding 510 can include information about the notification such as the relationship between the user being notified and the content of the notification, the timing of the notification, the type of notification, etc. When trained using action embedding 510, causal transformer component 245 can make more accurate recommendations of actions since it is trained on the meaning of those actions and not just the result of those actions.

In some embodiments, subsequence embedding component 235 applies time embedding 515 to trajectory subsequences 206. For example, subsequence embedding component 235 applies time embedding 515 to trajectory subsequences 206 to associate each data tuple of trajectory subsequences 206 with its associated timestamp. Time embedding 515 helps the model learn how much influence data tuples have based on how long ago the corresponding actions occurred. For example, data collected further in the past is less relevant to current decisions than data collected more recently. In some embodiments, time embedding 515 includes embedding for a relational time, such as the day of the week, hour of the day, etc. For example, time embedding 515 includes sparse embeddings for the day of the week, hour of the day, etc. such that causal transformer component 245 learns differences in outcomes for certain actions based on these relational times. In one embodiment, causal transformer component 245 learns that a user is more likely to interact with a notification during the week than during the weekend based on time embedding 515. In some embodiments, time embedding 515 includes time2vec and/or PinnerFormer time embeddings.

Subsequence embedding component 235 sends embedded subsequences 208 to causal transformer component 245. In some embodiments, as mentioned above, subsequence embedding component 235 is included as a layer of causal transformer component 245. For example, inputs to causal transformer component 245 are fed into an input embedding component and then positional encodings are added before entering the encoder layers of causal transformer component 245 (e.g., encoder 605 of FIG. 6). Similarly, outputs from causal transformer component 245 are shifted and fed into an output embedding component and then positional encodings are added before entering the decoder layers of causal transformer component 245. (e.g., decoder 615 of FIG. 6).

FIG. 6 illustrates an example computing system that includes a causal transformer component in accordance with some embodiments of the present disclosure.

In the embodiment of FIG. 6, computing system 600 includes causal transformer component 245, notification delivery component 160, and user system 110. Subsequence embedding component 235 of user trajectory processing system 100 is described in more detail below. Causal transformer component 245 of computing system 600 is described in more detail below.

In some embodiments, the causal transformer component 245 is constructed using a neural network-based machine learning model architecture. In some embodiments, the neural network-based architecture includes one or more self-attention layers (e.g., multi-head attention layer 602, masked multi-head attention layer 610, and multi-head attention layer 614) that allow the model to assign different weights to different features included in the model input. Alternatively, or in addition, the neural network architecture includes feed-forward layers (e.g., feed-forward layer 606 and feed-forward layer 618) and residual connections (e.g., add & norm layer 604, add & norm layer 608, add & norm layer 612, add & norm layer 616, add & norm layer 620) that allow the model to machine-learn complex data patterns including relationships between different states, actions, and rewards in multiple different contexts. In some embodiments, causal transformer component 245 is constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation of the user trajectory processing system.

As shown in FIG. 6, causal transformer component 245 feeds embedded subsequences 208 into encoder 605 and decoder 615. For example, causal transformer component 245 feeds inputs of embedded subsequences 208 into multi-head attention layer 602 of encoder 605. In some embodiments, inputs of embedded subsequences 208 are a series of tokens and the output of the encoder (e.g., encoder output representation 625), is a fixed-dimensional representation for each of the tokens of embedded subsequences 208 including an embedding for inputs of embedded subsequences 208 (e.g., one or more of position embedding 505, action embedding 510, and time embedding 515 of FIG. 5). Causal transformer component 245 feeds encoder output representation 625 and outputs of embedded subsequences 208 into decoder 615 which generates a sequence of tokens based on encoder output representation 625 and the input embeddings. While a specific architecture of encoder 605 and decoder 615 is shown for simplicity, as explained above, the exact number and arrangement of layers of each type as well as the hyperparameter values used to configure the model are determined based on the requirements of a particular design or implementation. Causal transformer component 245 can therefore include different numbers, arrangements, and types of layers, such that each input token of embedded subsequences 208 is fed through the layers of causal transformer component 245 and is dependent on other input tokens of embedded subsequences 208.

As mentioned above, causal transformer component 245 illustrates a generic encoder/decoder model for simplicity. In such a model, encoder 605 encodes the input into a fixed-length vector (e.g., encoder output representation 625) and decoder 615 decodes the fixed-length vector into an output sequence. Encoder 605 and decoder 615 are trained together to maximize the conditional log-likelihood of the output given the input. For example, once trained, encoder 605 and decoder 615 can generate an output given an input sequence or can score a pair of input/output sequences based on their probability of coexistence.

As shown in FIG. 6, encoder 605 includes multi-head attention layer 602, add & norm layer 604, feed-forward layer 606, and add & norm layer 608. Multi-head attention layer 602 receives inputs of embedded subsequences 208 and computes output representations for each of the input tokens of embedded subsequences 208 based on the inputs of embedded subsequences 208. For example, multi-head attention layer 602 converts each input token of embedded subsequences 208 into a queries, keys, and values using query, key, and value matrices. Multi-head attention layer 602 computes the output representation of the input tokens of embedded subsequences 208 as the weighted sum of the values of all of the input tokens of embedded subsequences 208. Multi-head attention layer 602 computes the weights for the weighted sum by applying a compatibility function to the corresponding key and query for the value. For example, multi-head attention layer 602 uses a scaled dot product on the key and query of an input token to determine a weight to apply to a value of the input token. Multi-head attention layer 602 includes multiple attention blocks which each compute an output representation for the input token. Multi-head attention layer 602 aggregates the output representations of these attention blocks to generate a final output representation for multi-head attention layer 602.

Inputs of embedded subsequences 208 includes the state of the online system at a given timestamp and the action taken at that state. For example, inputs of embedded subsequences 208 includes the state features and actions of embedded subsequences 208. Causal transformer component 245 feeds the output representation generated by multi-head attention layer 602 and residual connections from the inputs of embedded subsequences 208 into add & norm layer 604. By including these residual connections, causal transformer component 245 ensures that it does not forget features of embedded subsequences 208 during training. Add & norm layer 604 sums the output representation generated by multi-head attention layer 602 and the residual connections from inputs of embedded subsequences 208 and applies a layer normalization to the result. In some embodiments, the add & normal layers also apply a SoftMax function to generate action probabilities for the inputs of embedded subsequences 208. For example, add & norm layer 608 generates estimated probabilities \hat{p}(aₖ|s), where aₖ is the action policy and s is the state features.

Causal transformer component 245 feeds the normalized output of add & norm layer 604 into feed-forward layer 606. Feed-forward layer 606 is a feed-forward network that receives the normalized output, feeds it through the hidden layers of feed-forward layer 606, and then feeds the output of feed-forward layer 606 into add & norm layer 608. Feed-forward layer 606 processes the information received from add & norm layer 604 and can update the hidden layers of feed-forward layer 606 based on the information (e.g., during training) and/or generate an output based on the hidden layers processing the information (e.g., during evaluation and/or inference). For example, during training, causal transformer component 245 updates the weights of the hidden layers of feed-forward layer 606 based on the inputs and the loss of the transformer system. Further details with regard to the loss of the transformer system as well as training objectives and metrics are discussed below. As an alternative example, during evaluation and/or inference, the weights of the hidden layers of feed-forward layer 606 are used to determine the output representation of each of the input tokens of embedded subsequences 208.

Causal transformer component 245 feeds the output of feed-forward layer 606 into add & norm layer 608 as well as residual connections from the output of add & norm layer 604. Add & norm layer 608 sums the output of feed-forward layer 606 with the residual connections from add & norm layer 604 and applies a layer normalization to the result to generate encoder output representation 625. Causal transformer component 245 feeds encoder output representation 625 into multi-head attention layer 614 of decoder 615 as explained below.

Masked multi-head attention layer 610 receives outputs of embedded subsequences 208 and computes representations for each of the output tokens of embedded subsequences 208 based on masked outputs of embedded subsequences 208. For example, masked multi-head attention layer 610 computes representations for each of the output tokens of embedded subsequences 208 based on previous output tokens while masking future output tokens. Masked multi-head attention layer 610 therefore only computes representations using tokens that come before the token masked multi-head attention layer 610 is trying to predict. Outputs of embedded subsequences 208 includes the rewards for actions of the online system. For example, outputs of embedded subsequences 208 includes the rewards of embedded subsequences 208. By masking future rewards, decoder 615 is prevented from results from later times to predict a reward for a prior timestamp. Causal transformer component 245 feeds the representation generated by masked multi-head attention layer 610 and residual connections from the outputs of embedded subsequences 208 into add & norm layer 612. Add & norm layer 612 sums the representation generated by masked multi-head attention layer 610 and the residual connections from outputs of embedded subsequences 208 and applies a layer normalization to the result.

Causal transformer component 245 feeds the normalized output of add & norm layer 616 into multi-head attention layer 614. Multi-head attention layer 614 receives the normalized output of add & norm layer 612 as well as encoder output representation 625 from encoder 605 and generates a representation based on both. For example, multi-head attention layer 614 generates a representation using queries from the output of add & norm layer 612 and keys and values from encoder output representation 625. Causal transformer component 245 feeds the representation generated by multi-head attention layer 614 and residual connections from the output of add & norm layer 612 into add & norm layer 616. Add & norm layer 616 sums the representation generated by multi-head attention layer 614 and the residual connections from the output of add & norm layer 612 and applies a layer normalization to the result.

Causal transformer component 245 feeds the normalized output of add & norm layer 616 into feed-forward layer 618. Feed-forward layer 618 is a feed-forward network that receives the normalized output, feeds it through the hidden layers of feed-forward layer 618, and then feeds the output of feed-forward layer 618 into add & norm layer 620. Feed-forward layer 618 processes the information received from add & norm layer 616 and can update the hidden layers of feed-forward layer 618 based on the information (e.g., during training) and/or generate an output based on the hidden layers processing the information (e.g., during evaluation and/or inference). For example, during training, causal transformer component 245 updates the weights of the hidden layers of feed-forward layer 618 based on the inputs and the loss of the transformer system. Further details with regard to the loss of the transformer system as well as training objectives and metrics are discussed below. As an alternative example, during evaluation and/or inference, the weights of the hidden layers of feed-forward layer 618 are used to determine the output out feed-forward layer 618.

Causal transformer component 245 feeds the output of feed-forward layer 618 into add & norm layer 620 as well as residual connections from the output of add & norm layer 616. Add & norm layer 620 sums the output of feed-forward layer 618 with the residual connections from add & norm layer 616 and applies a layer normalization to the result to generate an output.

Causal transformer component 245 generates output probabilities 626 from the output of add & norm layer 620. For example, causal transformer component 245 applies a linear transformation and a softmax function to the output of add & norm layer 620 to generate a normalized vector of output probabilities 626. In some embodiments, causal transformer component 245 sends action option 210 based on output probabilities 626. For example, causal transformer component 245 determines an optimal action policy to maximize long-term rewards based on output probabilities 626.

In some embodiments, such as during training, causal transformer component 245 determines a loss for the system based on output probabilities 626. For example, causal transformer component 245 uses deep quantile regression for training. In such an example, output probabilities 626 includes a mean prediction probability and estimations for the upper and lower bounds of the range of prediction such that output probabilities 626 includes an uncertainty range. In one embodiment, the loss function of causal transformer component 245 using deep quantile regression is represented by the following equation:

$$L ( {ξ}_{i} \vert α ) = \{ \begin{matrix}{αξ}_{i} & if {ξ}_{i} \geq 0 , \\ ( α - 1 ) {ξ}_{i} & if {ξ}_{i} < 0\end{matrix} ,$$

where α is the required quantile (a value between 0 and 1 representing the desired quantile) and ξᵢ=yᵢ−f(xᵢ), where f(xᵢ) is the mean predicted by output probabilities 626, yᵢ are the outputs of embedded subsequences 208 and xᵢ are the inputs of embedded subsequences 208. The loss over the entirety of a dataset of embedded subsequences 208 where embedded subsequences 208 has a length of N can be represented by the following equation:

$$ℒ ( y , f \vert α ) = \frac{1}{N} {\sum }_{i = 1}^{N} ℒ ( {y}_{i} - f ( {x}_{i} ) \vert α ) .$$

In such embodiments, output probabilities 626 includes three values: a mean prediction, a lower bound quantile, and an upper bound quantile. In some embodiments, causal transformer component 245 uses upper confidence bound or Thompson sampling. For example, causal transformer component 245 can determine action option 210 to take based on the mean prediction, the lower bound quantile, and the upper bound quantile based on upper confidence bound and/or Thompson sampling. In some embodiments, the value of the upper quantile is a tuning parameter for causal transformer component 245. For example, an optimal value for the upper quantile is determined and set for causal transformer component 245 before evaluation and/or inference. In some embodiments action option 210 is the best action option for user trajectory processing system 200 as determined based on output probabilities 626.

In some embodiments, causal transformer component 245 is trained to optimize the model parameters with trajectory-specific normalizations using cross-entropy loss. For example, causal transformer component 245 uses a loss function represented by the following equation:

$$L ( θ ) = \frac{1}{{N}_{t r a j}} {\sum }_{i}^{{N}_{t r a j}} {\sum }_{t = 1}^{{T}_{i}} {w}_{i} {\sum }_{k} log ( \hat{p} ( {a}_{k}^{( it )} \vert {s}^{( it )} ) ) ,$$

where Nₜᵣₐⱼ is the trajectory count, wᵢ is the normalization weight, aₖ^{(it)} is the predicted action for the trajectory i at timestep t, and s^{(it)} is the state of the online system for the trajectory i at timestep t. In some embodiments, causal transformer component 245 uses trajectory-wise normalization. For example, the add & norm layers of causal transformer component 245 normalize the weights according to the following equation:

$${w}_{i} = \frac{1}{{T}_{i}} ,$$

where Tᵢ is the length of trajectory i. In some embodiments, causal transformer component 245 uses global normalization. For example, the add & norm layers of causal transformer component 245 normalize the weights according to the following equation: wᵢ=c, where c is a positive scalar. In some embodiments, the scalar c is predetermined.

Causal transformer component 245 sends action option 210 to notification delivery component 160. For example, causal transformer component 245 sends an optimal action policy for an online system to a notification delivery component of the online system. In some embodiments, notification delivery component 160 receives action option 210 and sends notification 212 to user system 110. For example, notification delivery component 160 causes notification 212 to be displayed on a user interface of user system 110 (e.g., user interface 112 of FIG. 1) based on action option 210. In some embodiments, as mentioned above, the problem is a multi-objective problem and notification delivery component 160 has multiple options for sending notification 212. For example, notification delivery component 160 can send notification 212 as a push notification or as a badge notification or drop the notification. Additionally, notification 212 is based on the optimal notification to send to the user as determined by user trajectory processing system 200.

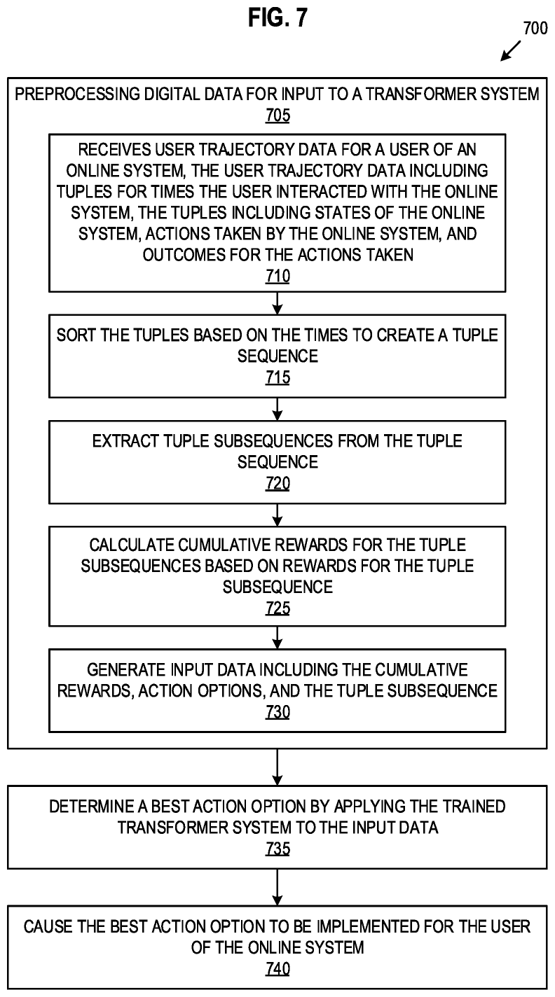

FIG. 7 is a flow diagram of an example method 700 to process user trajectory data, in accordance with some embodiments of the present disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by user trajectory processing component 150 of FIG. 1. In some embodiments, parts of the method 700 are performed by user trajectory processing component 150 and parts of the method 700 are performed by notification delivery component 160 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 705, the processing device preprocesses digital data for input to a transformer system. For example, user trajectory processing component 150 receives user trajectory data 202 from feature storage 205 and generates embedded subsequences 208 for input into causal transformer component 245. Further details with regard to preprocesses the digital data are explained with reference to FIGS. 2-6.

At operation 710, the processing device receives user trajectory data for a user of an online system. The user trajectory data includes data tuples for times the user interacted with the online system. The data tuples include states of the online system, actions taken by the online system, and outcomes for the actions taken. For example, data tuple preprocessing component 215 receives user trajectory data 202 from feature storage 205 for a user of user system 110. User trajectory data 202 can include state features from feature storage 310, rewards actions from action storage 315 and outcomes for the actions, also known as rewards, from reward storage 305. In some embodiments, user trajectory data includes context features stored in feature storage 310 as well. In some embodiments, the processing device processes the tuples. For example, data tuple preprocessing component 215 processes the state features, context features, actions, and rewards as explained with reference to FIG. 3. Further details with regard to receiving user trajectory data are explained with reference to FIGS. 2-6.

At operation 715, the processing device sorts the tuples based on the times to create a tuple sequence. For example, user trajectory processing component 150 sorts user trajectory data 202 using the associated timestamps. Further details with regard to sorting the tuples are explained with reference to FIGS. 2-6.

At operation 720, the processing device extracts tuple subsequences from the tuple sequence. For example, trajectory preprocessing component 225 generates trajectory subsequences 206 from processed trajectory data 204. In some embodiments, the processing device extracts the tuple subsequences based on a subsequence length. For example, trajectory preprocessing component 225 generates trajectory subsequences 206 as a number of consecutive tuples equal to a subsequence inference length. Further details with regard to extracting tuple subsequences are explained with reference to FIGS. 2-6.

At operation 725, the processing device calculates cumulative rewards for the tuple subsequences based on rewards for the tuple subsequence. For example, data tuple preprocessing component 215 applies RewardToGo conversion 340 on rewards from reward storage 305 to calculate cumulative rewards, also known as reward-to-gos. Further details with regard to calculating cumulative rewards are explained with reference to FIGS. 2-6.

At operation 730, the processing device generates input data including the cumulative rewards, action options, and the tuple subsequence. For example, user trajectory processing component 150 generates embedded subsequences 208 for input to causal transformer component 245. Further details with regard to generating the input data are explained with reference to FIGS. 2-6.

At operation 735, the processing device determines a best action option by applying the trained transformer system to the input data. For example, user trajectory processing component 150 applies causal transformer component 245 to embedded subsequences 208 to generate output probabilities 626 and determines action option 210 as the best action option based on output probabilities 626. Further details with regard to determining the best action option are explained with reference to FIGS. 2-6.

At operation 740, the processing device causes the best action option to be implemented for the user of the online system. For example, notification delivery component 160 sends notification 212 to user system 110, causing notification 212 to be displayed on user interface 112 of user system 110. Further details with regard to causing the best action option to be implemented are explained with reference to FIGS. 2-6.

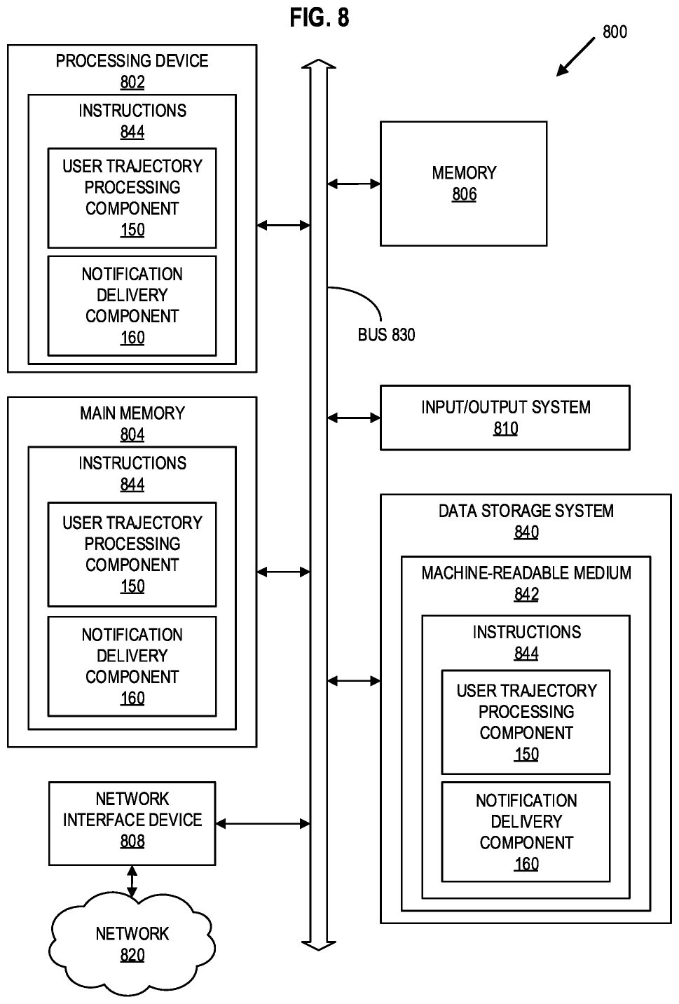

FIG. 8 illustrates an example machine of a computer system 800 within which a set of instructions, for causing the machine to perform any one or more of the methodologies discussed herein, can be executed. In some embodiments, the computer system 800 can correspond to a component of a networked computer system (e.g., the user trajectory processing system 100 of FIG. 1) that includes, is coupled to, or utilizes a machine to execute an operating system to perform operations corresponding to user trajectory processing component 150 and/or notification delivery component 160 of FIG. 1. The machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random-access memory (DRAM) such as synchronous DRAM (SDRAM) or Rambus DRAM (RDRAM), etc.), a memory 806 (e.g., flash memory, static random-access memory (SRAM), etc.), an input/output system 810, and a data storage system 840, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 844 for performing the operations and steps discussed herein.

The computer system 800 can further include a network interface device 808 to communicate over network 820. Network interface device 808 can provide a two-way data communication coupling to a network. For example, network interface device 808 can be an integrated-services digital network (ISDN) card, cable modem, satellite modem, or a modem to provide a data communication connection to a corresponding type of telephone line. As another example, network interface device 808 can be a local area network (LAN) card to provide a data communication connection to a compatible LAN. Wireless links can also be implemented. In any such implementation network interface device 808 can send and receive electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 800.

Computer system 800 can send messages and receive data, including program code, through the network(s) and network interface device 808. In the Internet example, a server can transmit a requested code for an application program through the Internet and network interface device 808. The received code can be executed by processing device 802 as it is received, and/or stored in data storage system 840, or other non-volatile storage for later execution.

The input/output system 810 can include an output device, such as a display, for example a liquid crystal display (LCD) or a touchscreen display, for displaying information to a computer user, or a speaker, a haptic device, or another form of output device. The input/output system 810 can include an input device, for example, alphanumeric keys and other keys configured for communicating information and command selections to processing device 802. An input device can, alternatively or in addition, include a cursor control, such as a mouse, a trackball, or cursor direction keys for communicating direction information and command selections to processing device 802 and for controlling cursor movement on a display. An input device can, alternatively or in addition, include a microphone, a sensor, or an array of sensors, for communicating sensed information to processing device 802. Sensed information can include voice commands, audio signals, geographic location information, and/or digital imagery, for example.

The data storage system 840 can include a machine-readable storage medium 842 (also known as a computer-readable medium) on which is stored one or more sets of instructions 844 or software embodying any one or more of the methodologies or functions described herein. The instructions 844 can also reside, completely or at least partially, within the main memory 804 and/or within the processing device 802 during execution thereof by the computer system 800, the main memory 804 and the processing device 802 also constituting machine-readable storage media.

In one embodiment, instructions 844 include instructions to implement functionality corresponding to a user trajectory processing component (e.g., user trajectory processing component 150 of FIG. 1). In another embodiment, instructions 844 include instructions to implement functionality corresponding to a notification delivery component (e.g., notification delivery component 160 of FIG. 1). In yet another embodiment, the instructions 844 include instructions to implement functionality corresponding to a user trajectory processing component and a notification delivery component (e.g., user trajectory processing component 150 and notification delivery component 160 of FIG. 1). While the machine-readable storage medium 842 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

An example 1 includes a method comprising: preprocessing digital data for input to a trained transformer system, wherein the preprocessing comprises: (i) receiving user trajectory data for a user of an online system, wherein the user trajectory data comprises a plurality of tuples for a plurality of times at which the user interacted with the online system, a tuple of the plurality of tuples comprising a state of the online system at a time of the plurality of times, an action taken by the online system at the time, and a reward for the action; (ii) sorting the plurality of tuples based on the plurality of times to create a tuple sequence; (iii) extracting a plurality of tuple subsequences from the tuple sequence based on a subsequence length (iv) calculating a plurality of cumulative rewards for a tuple subsequence of the plurality of tuple subsequences based on rewards for the tuple subsequence of the plurality of rewards; and (v) generating input data comprising the plurality of cumulative rewards, a plurality of action options, and the tuple subsequence, wherein an action option of the plurality of action options comprises an operation that is capable of being performed for the user by the online system; determining a best action option from the plurality of action options by applying the trained transformer system to the input data; and causing the best action option to be implemented for the user of the online system. An example 2 includes the subject matter of example 1, wherein the user trajectory data further comprises context features for the plurality of tuples and wherein the input data further comprises the context features. An example 3 includes the subject matter of any of examples 1 and 2, wherein the plurality of tuples includes a plurality of states of the online system and wherein the preprocessing further comprises: determining a data type for a state of the plurality of states of the online system; and transforming the state based on the data type. An example 4 includes the subject matter of any of examples 1-3, wherein the plurality of tuples includes a plurality of actions taken by the online system and wherein preprocessing further comprises: determining a plurality of action embeddings based on the plurality of actions, wherein sorting the plurality of tuples comprises: creating the tuple sequence using the plurality of action embeddings. An example 5 includes the subject matter of any of examples 1-4, wherein extracting the plurality of tuple subsequences is based on a subsequence length, wherein a tuple subsequence of the plurality of tuple subsequences comprises a number of consecutive tuples from the tuple sequence and the number of consecutive tuples is equal to the subsequence length. An example 6 includes the subject matter of any of examples 1-5, wherein determining the best action option from the plurality of action options comprises: determining a mean prediction, a lower bound quantile, and an upper bound quantile for the plurality of action options; and determining the best action option using at least one of the mean prediction, the lower bound quantile, and the upper bound quantile. An example 7 includes the subject matter of any of examples 1-6, wherein the preprocessing further comprises: estimating a plurality of future cumulative rewards for the tuple subsequence for the plurality of action options using an average of reward values from training the trained transformer system, wherein the input data further comprises the plurality of future cumulative rewards. An example 8 includes the subject matter of any of examples 1-7, wherein the plurality of tuples are for the plurality of times at which the user interacted with the online system in response to receiving a notification, wherein the plurality of action options include at least one of sending a badge notification, sending a push notification, and dropping the notification, and wherein causing the best action option to be implemented for the user of the online system comprises at least one of sending the badge notification, sending the push notification, and not sending the notification. An example 9 includes the subject matter of any of examples 1-8, wherein generating the input data comprises: encoding the plurality of cumulative rewards, the plurality of action options, and the tuple subsequence based on a respective position of the plurality of cumulative rewards, the plurality of action options, and the tuple subsequence in the input data. An example 10 includes the subject matter of any of examples 1-9, wherein generating the input data comprises: generating a time embedding for the plurality of cumulative rewards, the plurality of action options, and the tuple subsequence based on the plurality of times.

An example 11 includes a system comprising: at least one memory device; and a processing device, operatively coupled with the at least one memory device, to: preprocess digital data for input to a trained transformer system, wherein the preprocessing comprises: (i) receiving user trajectory data for a user of an online system, wherein the user trajectory data comprises a plurality of tuples for a plurality of times at which the user interacted with the online system, a tuple of the plurality of tuples comprising a state of the online system at a time of the plurality of times, an action taken by the online system at the time, and a reward for the action; (ii) sorting the plurality of tuples based on the plurality of times to create a tuple sequence; (iii) extracting a plurality of tuple subsequences from the tuple sequence based on a subsequence length (iv) calculating a plurality of cumulative rewards for a tuple subsequence of the plurality of tuple subsequences based on rewards for the tuple subsequence of the plurality of rewards; and (v) generating input data comprising the plurality of cumulative rewards, a plurality of action options, and the tuple subsequence, wherein an action option of the plurality of action options comprises an operation that is capable of being performed for the user by the online system; determine a best action option from the plurality of action options by applying the trained transformer system to the input data; and cause the best action option to be implemented for the user of the online system. An example 12 includes the subject matter of example 11, wherein the user trajectory data further comprises context features for the plurality of tuples and wherein the input data further comprises the context features. An example 13 includes the subject matter of any of examples 11 and 12, wherein the plurality of tuples includes a plurality of states of the online system and wherein the preprocessing further comprises: determining a data type for a state of the plurality of states of the online system; and transforming the state based on the data type. An example 14 includes the subject matter of any of examples 11-13, wherein the plurality of tuples includes a plurality of actions taken by the online system and wherein preprocessing further comprises: determining a plurality of action embeddings based on the plurality of actions, wherein sorting the plurality of tuples comprises: creating the tuple sequence using the plurality of action embeddings. An example 15 includes the subject matter of any of examples 11-14, wherein extracting the plurality of tuple subsequences is based on a subsequence length, wherein a tuple subsequence of the plurality of tuple subsequences comprises a number of consecutive tuples from the tuple sequence and the number of consecutive tuples is equal to the subsequence length. An example 16 includes the subject matter of any of examples 11-15, wherein determining the best action option from the plurality of action options comprises: determining a mean prediction, a lower bound quantile, and an upper bound quantile for the plurality of action options; and determining the best action option using at least one of the mean prediction, the lower bound quantile, and the upper bound quantile. An example 17 includes the subject matter of any of examples 11-16, wherein the preprocessing further comprises: estimating a plurality of future cumulative rewards for the tuple subsequence for the plurality of action options using an average of reward values from training the trained transformer system, wherein the input data further comprises the plurality of future cumulative rewards. An example 18 includes the subject matter of any of examples 11-17, wherein the plurality of tuples are for the plurality of times at which the user interacted with the online system in response to receiving a notification, wherein the plurality of action options include at least one of sending a badge notification, sending a push notification, and dropping the notification, and wherein causing the best action option to be implemented for the user of the online system comprises at least one of sending the badge notification, sending the push notification, and not sending the notification. An example 19 includes the subject matter of any of examples 11-18, wherein generating the input data comprises: encoding the plurality of cumulative rewards, the plurality of action options, and the tuple subsequence based on a respective position of the plurality of cumulative rewards, the plurality of action options, and the tuple subsequence in the input data.

Example 20 includes a system comprising: at least one memory device; and a processing device, operatively coupled with the at least one memory device, to: preprocess digital data for input to a trained transformer system, wherein the preprocessing comprises: (i) receiving user trajectory data for a user of an online system, wherein the user trajectory data comprises a plurality of tuples for a plurality of times at which the user interacted with the online system, a tuple of the plurality of tuples comprising a state of the online system at a time of the plurality of times, an action taken by the online system at the time, and a reward for the action; (ii) sorting the plurality of tuples based on the plurality of times to create a tuple sequence; (iii) extracting a plurality of tuple subsequences from the tuple sequence based on a subsequence length (iv) calculating a plurality of cumulative rewards for a tuple subsequence of the plurality of tuple subsequences based on rewards for the tuple subsequence of the plurality of rewards; and (v) estimating a plurality of future cumulative rewards for the tuple subsequence for a plurality of action options using an average of reward values from training the trained transformer system (vi) generating input data comprising the plurality of cumulative rewards, the plurality of future cumulative rewards, the plurality of action options, and the tuple subsequence, wherein an action option of the plurality of action options comprises an operation that is capable of being performed for the user by the online system; determine a best action option from the plurality of action options by applying the trained transformer system to the input data; and cause the best action option to be implemented for the user of the online system.

The techniques described herein may be implemented with privacy safeguards to protect user privacy. Furthermore, the techniques described herein may be implemented with user privacy safeguards to prevent unauthorized access to personal data and confidential data. The training of the artificial intelligence (AI) models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the user trajectory processing system 100, can carry out the computer-implemented method 700 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples or a combination of the described below.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
preprocessing digital data for input to a trained transformer system, wherein the preprocessing comprises:
(i) receiving user trajectory data for a user of an online system, wherein the user trajectory data comprises a plurality of tuples for a plurality of times at which the user interacted with the online system, a tuple of the plurality of tuples comprising a state of the online system at a time of the plurality of times, an action taken by the online system at the time, and a reward for the action;
(ii) sorting the plurality of tuples based on the plurality of times to create a tuple sequence;
(iii) extracting a plurality of tuple subsequences from the tuple sequence based on a subsequence length;
(iv) calculating a plurality of cumulative rewards for a tuple subsequence of the plurality of tuple subsequences based on rewards for the tuple subsequence of the plurality of rewards; and
(v) generating input data comprising the plurality of cumulative rewards, a plurality of action options, and the tuple subsequence, wherein an action option of the plurality of action options comprises an operation that is capable of being performed for the user by the online system;
determining a best action option from the plurality of action options by applying the trained transformer system to the input data; and
causing the best action option to be implemented for the user of the online system.

2. The method of claim 1, wherein the user trajectory data further comprises context features for the plurality of tuples and wherein the input data further comprises the context features.

3. The method of claim 1, wherein the plurality of tuples includes a plurality of states of the online system and wherein the preprocessing further comprises:
determining a data type for a state of the plurality of states of the online system; and
transforming the state based on the data type.

4. The method of claim 1, wherein the plurality of tuples includes a plurality of actions taken by the online system and wherein preprocessing further comprises:
determining a plurality of action embeddings based on the plurality of actions, wherein sorting the plurality of tuples comprises:
creating the tuple sequence using the plurality of action embeddings.

5. The method of claim 1, wherein extracting the plurality of tuple subsequences is based on a subsequence length, wherein a tuple subsequence of the plurality of tuple subsequences comprises a number of consecutive tuples from the tuple sequence and the number of consecutive tuples is equal to the subsequence length.

6. The method of claim 1, wherein determining the best action option from the plurality of action options comprises:
determining a mean prediction, a lower bound quantile, and an upper bound quantile for the plurality of action options; and
determining the best action option using at least one of the mean prediction, the lower bound quantile, and the upper bound quantile.

7. The method of claim 1, wherein the preprocessing further comprises:
estimating a plurality of future cumulative rewards for the tuple subsequence for the plurality of action options using an average of reward values from training the trained transformer system, wherein the input data further comprises the plurality of future cumulative rewards.

8. The method of claim 1, wherein the plurality of tuples are for the plurality of times at which the user interacted with the online system in response to receiving a notification, wherein the plurality of action options include at least one of sending a badge notification, sending a push notification, and dropping the notification, and wherein causing the best action option to be implemented for the user of the online system comprises at least one of sending the badge notification, sending the push notification, and not sending the notification.

9. The method of claim 1, wherein generating the input data comprises:
encoding the plurality of cumulative rewards, the plurality of action options, and the tuple subsequence based on a respective position of the plurality of cumulative rewards, the plurality of action options, and the tuple subsequence in the input data.

10. The method of claim 1, wherein generating the input data comprises:
generating a time embedding for the plurality of cumulative rewards, the plurality of action options, and the tuple subsequence based on the plurality of times.

11. A system comprising:
at least one memory device; and
a processing device, operatively coupled with the at least one memory device, to:
preprocess digital data for input to a trained transformer system, wherein the preprocessing comprises:
(i) receiving user trajectory data for a user of an online system, wherein the user trajectory data comprises a plurality of tuples for a plurality of times at which the user interacted with the online system, a tuple of the plurality of tuples comprising a state of the online system at a time of the plurality of times, an action taken by the online system at the time, and a reward for the action;
(ii) sorting the plurality of tuples based on the plurality of times to create a tuple sequence;
(iii) extracting a plurality of tuple subsequences from the tuple sequence based on a subsequence length;
(iv) calculating a plurality of cumulative rewards for a tuple subsequence of the plurality of tuple subsequences based on rewards for the tuple subsequence of the plurality of rewards; and
(v) generating input data comprising the plurality of cumulative rewards, a plurality of action options, and the tuple subsequence, wherein an action option of the plurality of action options comprises an operation that is capable of being performed for the user by the online system;
determine a best action option from the plurality of action options by applying the trained transformer system to the input data; and
cause the best action option to be implemented for the user of the online system.

12. The system of claim 11, wherein the user trajectory data further comprises context features for the plurality of tuples and wherein the input data further comprises the context features.

13. The system of claim 11, wherein the plurality of tuples includes a plurality of states of the online system and wherein the preprocessing further comprises:
determining a data type for a state of the plurality of states of the online system; and
transforming the state based on the data type.

14. The system of claim 11, wherein the plurality of tuples includes a plurality of actions taken by the online system and wherein preprocessing further comprises:
determining a plurality of action embeddings based on the plurality of actions, wherein sorting the plurality of tuples comprises:
creating the tuple sequence using the plurality of action embeddings.

15. The system of claim 11, wherein extracting the plurality of tuple subsequences is based on a subsequence length, wherein a tuple subsequence of the plurality of tuple subsequences comprises a number of consecutive tuples from the tuple sequence and the number of consecutive tuples is equal to the subsequence length.

16. The system of claim 11, wherein determining the best action option from the plurality of action options comprises:
determining a mean prediction, a lower bound quantile, and an upper bound quantile for the plurality of action options; and
determining the best action option using at least one of the mean prediction, the lower bound quantile, and the upper bound quantile.

17. The system of claim 11, wherein the preprocessing further comprises:
estimating a plurality of future cumulative rewards for the tuple subsequence for the plurality of action options using an average of reward values from training the trained transformer system, wherein the input data further comprises the plurality of future cumulative rewards.

18. The system of claim 11, wherein the plurality of tuples are for the plurality of times at which the user interacted with the online system in response to receiving a notification, wherein the plurality of action options include at least one of sending a badge notification, sending a push notification, and dropping the notification, and wherein causing the best action option to be implemented for the user of the online system comprises at least one of sending the badge notification, sending the push notification, and not sending the notification.

19. The system of claim 11, wherein generating the input data comprises:
encoding the plurality of cumulative rewards, the plurality of action options, and the tuple subsequence based on a respective position of the plurality of cumulative rewards, the plurality of action options, and the tuple subsequence in the input data.

20. A system comprising:
at least one memory device; and
a processing device, operatively coupled with the at least one memory device, to:
preprocess digital data for input to a trained transformer system, wherein the preprocessing comprises:
(i) receiving user trajectory data for a user of an online system, wherein the user trajectory data comprises a plurality of tuples for a plurality of times at which the user interacted with the online system, a tuple of the plurality of tuples comprising a state of the online system at a time of the plurality of times, an action taken by the online system at the time, and a reward for the action;
(ii) sorting the plurality of tuples based on the plurality of times to create a tuple sequence;
(iii) extracting a plurality of tuple subsequences from the tuple sequence based on a subsequence length;
(iv) calculating a plurality of cumulative rewards for a tuple subsequence of the plurality of tuple subsequences based on rewards for the tuple subsequence of the plurality of rewards;
(v) estimating a plurality of future cumulative rewards for the tuple subsequence for a plurality of action options using an average of reward values from training the trained transformer system; and
(vi) generating input data comprising the plurality of cumulative rewards, the plurality of future cumulative rewards, the plurality of action options, and the tuple subsequence, wherein an action option of the plurality of action options comprises an operation that is capable of being performed for the user by the online system;
determine a best action option from the plurality of action options by applying the trained transformer system to the input data; and
cause the best action option to be implemented for the user of the online system.
